(19) United States
(12) Patent Application Publication
(10) Pub. No.: US 2020/0322590 A1
(43) Pub. Date: Oct. 8, 2020

(54) CROSS-RENDER MULTIVIEW CAMERA, SYSTEM, AND METHOD

(71) Applicant: LEIA INC., Menlo Park, CA (US)

(72) Inventors: David A. Fattal, Mountain View, CA (US); Roger Dass, Menlo Park, CA (US); Edmund A. Dao, Menlo Park, CA (US)

(21) Appl. No.: 16/905,779

(22) Filed: Jun. 18, 2020

Related U.S. Application Data
(63) Continuation of application No. PCT/US2018/064632, filed on Dec. 8, 2018.
(60) Provisional application No. 62/608,551, filed on Dec. 20, 2017.

(51) Int. Cl. H04N 13/271; F21V 8/00; H04N 13/282

(52) U.S. Cl. CPC H04N 13/271; H04N 13/282; G02B 6/0036

(57) ABSTRACT

A cross-render multiview camera provides a multiview image of a scene using a synthesized image generated from a disparity map of the scene. The cross-render multiview camera includes a plurality of cameras along a first axis and configured to capture a plurality of images of the scene. The cross-render multiview camera further includes an image synthesizer configured to generate the synthesized image from the disparity map determined from the image plurality, the synthesized image representing a view of the scene from a perspective corresponding to a location of a virtual camera on a second axis displaced from the first axis. A cross-render multiview system further includes a multiview display configured to display the multiview image. A method of cross-render multiview imaging includes capturing of the plurality of images of the scene and generating the synthesized image using the disparity map.

### CROSS-REFERENCE TO RELATED APPLICATIONS

This application is a continuation application of and claims the benefit of priority to International Application No. PCT/US2018/064632, filed Dec. 8, 2018, which claims the benefit of priority to U.S. Provisional Application No. 62/608,551, filed Dec. 20, 2017, the contents of both of which are hereby incorporated by reference.

### STATEMENT REGARDING FEDERALLY SPONSORED RESEARCH OR DEVELOPMENT

N/A

### BACKGROUND

Electronic displays are a nearly ubiquitous medium for communicating information to users of a wide variety of devices and products. Most commonly employed electronic displays include the cathode ray tube (CRT), plasma display panels (PDP), liquid crystal displays (LCD), electroluminescent displays (EL), organic light emitting diode (OLED) and active matrix OLEDs (AMOLED) displays, electrophoretic displays (EP) and various displays that employ electromechanical or electrofluidic light modulation (e.g., digital micromirror devices, electrowetting displays, etc.). Generally, electronic displays may be categorized as either active displays (i.e., displays that emit light) or passive displays (i.e., displays that modulate light provided by another source). Among the most obvious examples of active displays are CRTs, PDPs and OLEDs/AMOLEDs. Displays that are typically classified as passive when considering emitted light are LCDs and EP displays. Passive displays, while often exhibiting attractive performance characteristics including, but not limited to, inherently low power consumption, may find somewhat limited use in many practical applications given the lack of an ability to emit light.

Image capture and especially three-dimensional (3D) image capture typically involve substantial image processing of captured images to convert the captured images (e.g., typically two-dimensional images) into 3D images for display on a 3D display or a multiview display. The image processing may include, but is not limited to, depth estimation, image interpolation, image reconstruction, or other complicated processes that may produce significant time delay from the moment the images are captured to the moment those images are displayed.

### BRIEF DESCRIPTION OF THE DRAWINGS

Various features of examples and embodiments in accordance with the principles described herein may be more readily understood with reference to the following detailed description taken in conjunction with the accompanying drawings, where like reference numerals designate like structural elements, and in which:

FIG. 1A illustrates a perspective view of a multiview display in an example, according to an embodiment consistent with the principles described herein.

FIG. 1B illustrates a graphical representation of angular components of a light beam having a particular principal angular direction corresponding to a view direction of a multiview display in an example, according to an embodiment consistent with the principles described herein.

FIG. 2A illustrates a diagram of a cross-render multiview camera in an example, according to an embodiment consistent with the principles described herein.

FIG. 2B illustrates a perspective view of a cross-render multiview camera in an example, according to an embodiment consistent with the principles described herein.

FIG. 3A illustrates a graphic representation of images associated with a cross-render multiview camera in an example, according to an embodiment consistent with the principles described herein.

FIG. 3B illustrates a graphic representation of images associated with a cross-render multiview camera in another example, according to an embodiment consistent with the principles described herein.

FIG. 4 illustrates a block diagram of a cross-render multiview system 200 in an example, according to an embodiment consistent with the principles described herein.

FIG. 5A illustrates a cross-sectional view of a multiview display in an example, according to an embodiment consistent with the principles described herein.

FIG. 5B illustrates a plan view of a multiview display in an example, according to an embodiment consistent with the principles described herein.

FIG. 5C illustrates a perspective view of a multiview display in an example, according to an embodiment consistent with the principles described herein.

FIG. 6 illustrates a cross-sectional view of a multiview display including a broad-angle backlight in an example, according to an embodiment consistent with the principles described herein.

FIG. 7 illustrates a flow chart of a method of cross-render multiview imaging in an example, according to an embodiment consistent with the principles described herein.

Certain examples and embodiments have other features that are one of in addition to and in lieu of the features illustrated in the above-referenced figures. These and other features are detailed below with reference to the above-referenced figures.

### DETAILED DESCRIPTION

Embodiments and examples in accordance with the principles described herein provide multiview or ‘holographic’ imaging that may correspond to or be used in conjunction with a multiview display. In particular, according to various embodiments of the principles described herein, multiview imaging of a scene may be provided by a plurality of cameras arranged on along a first axis. The camera plurality is configured to capture a plurality of images of the scene. Image synthesis is then employed to generate a synthesized image representing a view of the scene from a perspective corresponding to a location of virtual camera on a second axis displaced from the first axis. According to various embodiments, the synthesized image is generated by image synthesis from a disparity or depth map of the scene. A multiview image comprising the synthesized image may then be provided and displayed, according to various embodiments. The multiview image may further comprise an image of the image plurality. Together one or more synthesized images and one or more images of the image plurality may be viewed on a multiview display as the multiview image. Moreover, viewing the multiview image on the multiview display may enable a viewer to perceive elements within the multiview image of the scene at different apparent depths within the physical environment when viewed on the multiview display, including perspective views of the scene not present in the image plurality captured by the cameras. As such, a cross-render multiview camera according to an embodiment of the principles described herein may produce a multiview image that, when viewed on the multiview display, provides a viewer with a ‘more complete’ three-dimensional (3D) viewing experience than would be possible with the camera plurality alone, according to some embodiments.

Herein a ‘two-dimensional display’ or ‘2D display’ is defined as a display configured to provide a view of a displayed image that is substantially the same regardless of a direction from which the displayed image is viewed on the 2D display (i.e., within a predefined viewing angle or range of the 2D display). A liquid crystal display (LCD) found in may smart phones and computer monitors are examples of 2D displays. In contrast herein, a ‘multiview display’ is defined as a display or display system configured to provide different views of a multiview image in or from different view directions. In particular, the different views may represent different perspective views of a scene or object of the multiview image. In some instances, a multiview display may also be referred to as a three-dimensional (3D) display, e.g., when simultaneously viewing two different views of the multiview image provides a perception of viewing a three-dimensional (3D) image. Uses of multiview displays and multiview systems applicable to the capture and display of multiview images described herein include, but are not limited to, mobile telephones (e.g., smart phones), watches, tablet computes, mobile computers (e.g., laptop computers), personal computers and computer monitors, automobile display consoles, cameras displays, and various other mobile as well as substantially non-mobile display applications and devices.

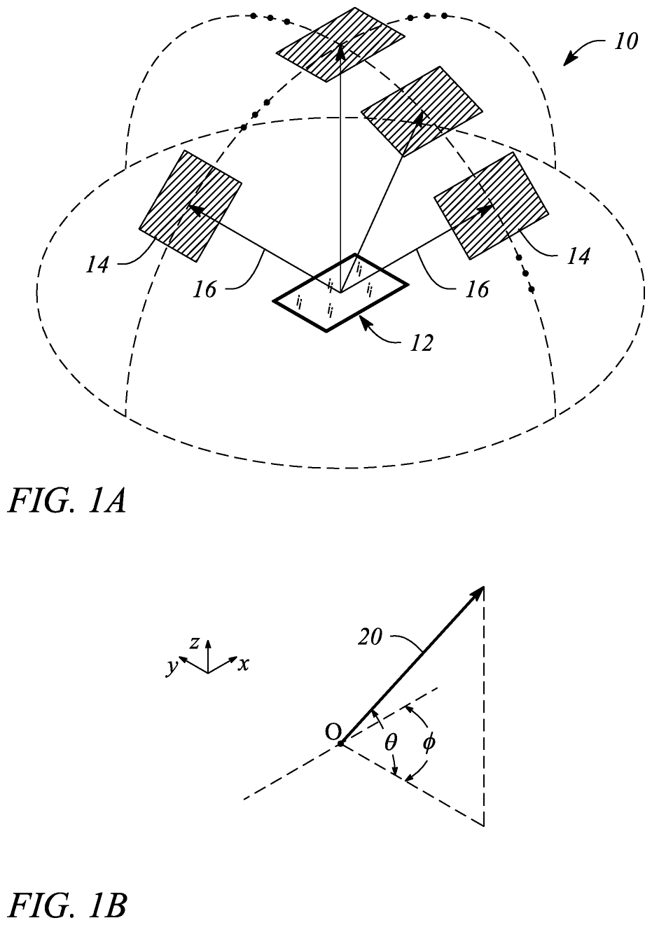

FIG. 1A illustrates a perspective view of a multiview display 10, according to an example consistent with the principles described herein. As illustrated, the multiview display 10 comprises a screen 12 that is viewed in order to see the multiview image. The multiview display 10 provides different views 14 of the multiview image in different view directions 16 relative to the screen 12. The view directions 16 are illustrated as arrows extending from the screen 12 in various different principal angular directions; the different views 14 are illustrated as shaded polygonal boxes at the termination of the arrows representing the view directions 16; and only four views 14 and view directions 16 are illustrated, all by way of example and not limitation. Note that while the different views 14 are illustrated in FIG. 1A as being above the screen, the views 14 actually appear on or in a vicinity of the screen 12 when a multiview image is displayed on the multiview display 10. Depicting the views 14 above the screen 12 is only for simplicity of illustration and is meant to represent viewing the multiview display 10 from a respective one of the view directions 16 corresponding to a particular view 14. Further, the views 14 and corresponding view directions 16 of the multiview display 10 are generally organized or arranged in a particular arrangement dictated by an implementation of the multiview display 10. For example, the views 14 and corresponding view directions 16 may have a rectangular arrangement, a square arrangement, circular arrangement, hexagonal arrangement, and so on, as dictated by a specific multiview display implementation, as further described below.

A view direction or equivalently a light beam having a direction corresponding to a view direction of a multiview display generally has a principal angular direction given by angular components {θ, φ}, by definition herein. The angular component θ is referred to herein as the ‘elevation component’ or ‘elevation angle’ of the light beam. The angular component φ is referred to as the ‘azimuth component’ or ‘azimuth angle’ of the light beam. By definition, the elevation angle θ is an angle in a vertical plane (e.g., perpendicular to a plane of the multiview display screen while the azimuth angle φ is an angle in a horizontal plane (e.g., parallel to the multiview display screen plane).

FIG. 1B illustrates a graphical representation of the angular components {θ, φ} of a light beam 20 having a particular principal angular direction corresponding to a view direction of a multiview display, according to an example of the principles described herein. In addition, the light beam 20 is emitted or emanates from a particular point, by definition herein. That is, by definition, the light beam 20 has a central ray associated with a particular point of origin within the multiview display. FIG. 1B also illustrates the light beam (or view direction) point of origin O.

Herein, ‘multiview’ as used in the terms ‘multiview image’ and ‘multiview display’ is defined as a plurality of views representing different perspectives or including angular disparity between views of the plurality. Further, the term ‘multiview’ by definition explicitly includes more than two different views (i.e., a minimum of three views and generally more than three views). As such, ‘multiview’ as employed herein is explicitly distinguished from stereoscopic views that include only two different views to represent a scene, for example. Note however, while multiview images and multiview displays include more than two views, by definition herein, multiview images may be viewed (e.g., on a multiview display) as a stereoscopic pair of images by selecting only two of the views to view at a time (e.g., one view per eye).

A ‘multiview pixel’ is defined herein as a set or group of sub-pixels (such as light valves) representing ‘view’ pixels in each view of a plurality of different views of a multiview display. In particular, a multiview pixel may have an individual sub-pixel corresponding to or representing a view pixel in each of the different views of the multiview image. Moreover, the sub-pixels of the multiview pixel are so-called ‘directional pixels’ in that each of the sub-pixels is associated with a predetermined view direction of a corresponding one of the different views, by definition herein. Further, according to various examples and embodiments, the different view pixels represented by the sub-pixels of a multiview pixel may have equivalent or at least substantially similar locations or coordinates in each of the different views. For example, a first multiview pixel may have individual sub-pixels corresponding to view pixels located at {x₁, y₁} in each of the different views of a multiview image, while a second multiview pixel may have individual sub-pixels corresponding to view pixels located at {x₂, y₂} in each of the different views, and so on.

In some embodiments, a number of sub-pixels in a multiview pixel may be equal to a number of different views of the multiview display. For example, the multiview pixel may provide, eight (8), sixteen (16), thirty-two (32), or sixty-four (64) sub-pixels in associated with a multiview display having 8, 16, 32, or 64 different views, respectively. In another example, the multiview display may provide a two by two array of views (i.e., 4 views) and the multiview pixel may include thirty-two 4 sub-pixels (i.e., one for each view). Additionally, each different sub-pixel may have an associated direction (e.g., light beam principal angular direction) that corresponds to a different one of the view directions corresponding to the different views, for example. Further, according to some embodiments, a number of multiview pixels of the multiview display may be substantially equal to a number of ‘view’ pixels (i.e., pixels that make up a selected view) in the multiview display views. For example, if a view includes six hundred forty by four hundred eighty view pixels (i.e., a 640×480 view resolution), the multiview display may have three hundred seven thousand two hundred (307,200) multiview pixels. In another example, when the views include one hundred by one hundred pixels, the multiview display may include a total of ten thousand (i.e., 100×100=10,000) multiview pixels.

Herein, a ‘light guide’ is defined as a structure that guides light within the structure using total internal reflection. In particular, the light guide may include a core that is substantially transparent at an operational wavelength of the light guide. The term ‘light guide’ generally refers to a dielectric optical waveguide that employs total internal reflection to guide light at an interface between a dielectric material of the light guide and a material or medium that surrounds the light guide. By definition, a condition for total internal reflection is that a refractive index of the light guide is greater than a refractive index of a surrounding medium adjacent to a surface of the light guide material. In some embodiments, the light guide may include a coating in addition to or instead of the aforementioned refractive index difference to further facilitate the total internal reflection. The coating may be a reflective coating, for example. The light guide may be any of several light guides including, but not limited to, one or both of a plate or slab guide and a strip guide.

Further herein, the term ‘plate’ when applied to a light guide as in a ‘plate light guide’ is defined as a piece-wise or differentially planar layer or sheet, which is sometimes referred to as a ‘slab’ guide. In particular, a plate light guide is defined as a light guide configured to guide light in two substantially orthogonal directions bounded by a top surface and a bottom surface (i.e., opposite surfaces) of the light guide. Additionally, by definition herein, the top and bottom surfaces are both separated from one another and may be substantially parallel to one another in at least a differential sense. That is, within any differentially small region of the plate light guide, the top and bottom surfaces are substantially parallel or co-planar.

In some embodiments, a plate light guide may be substantially flat (i.e., confined to a plane) and therefore, the plate light guide is a planar light guide. In other embodiments, the plate light guide may be curved in one or two orthogonal dimensions. For example, the plate light guide may be curved in a single dimension to form a cylindrical shaped plate light guide. However, any curvature has a radius of curvature sufficiently large to insure that total internal reflection is maintained within the plate light guide to guide light.

Herein, a ‘diffraction grating’ is generally defined as a plurality of features (i.e., diffractive features) arranged to provide diffraction of light incident on the diffraction grating. In some examples, the plurality of features may be arranged in a periodic or quasi-periodic manner. In other examples, the diffraction grating may be a mixed-period diffraction grating that includes a plurality of diffraction gratings, each diffraction grating of the plurality having a different periodic arrangement of features. Further, the diffraction grating may include a plurality of features (e.g., a plurality of grooves or ridges in a material surface) arranged in a one-dimensional (1D) array. Alternatively, the diffraction grating may comprise a two-dimensional (2D) array of features or an array of features that are defined in two dimensions. The diffraction grating may be a 2D array of bumps on or holes in a material surface, for example. In some examples, the diffraction grating may be substantially periodic in a first direction or dimension and substantially aperiodic (e.g., constant, random, etc.) in another direction across or along the diffraction grating.

As such, and by definition herein, the ‘diffraction grating’ is a structure that provides diffraction of light incident on the diffraction grating. If the light is incident on the diffraction grating from a light guide, the provided diffraction or diffractive scattering may result in, and thus be referred to as, ‘diffractive coupling’ in that the diffraction grating may couple light out of the light guide by diffraction. The diffraction grating also redirects or changes an angle of the light by diffraction (i.e., at a diffractive angle). In particular, as a result of diffraction, light leaving the diffraction grating (i.e., diffracted light) generally has a different propagation direction than a propagation direction of the light incident on the diffraction grating (i.e., incident light). The change in the propagation direction of the light by diffraction is referred to as ‘diffractive redirection’ herein. Hence, the diffraction grating may be understood to be a structure including diffractive features that diffractively redirects light incident on the diffraction grating and, if the light is incident from a light guide, the diffraction grating may also diffractively couple out the light from light guide.

Further, by definition herein, the features of a diffraction grating are referred to as ‘diffractive features’ and may be one or more of at, in and on a surface (i.e., wherein a ‘surface’ refers to a boundary between two materials). The surface may be a surface of a plate light guide. The diffractive features may include any of a variety of structures that diffract light including, but not limited to, one or more of grooves, ridges, holes and bumps, and these structures may be one or more of at, in and on the surface. For example, the diffraction grating may include a plurality of parallel grooves in a material surface. In another example, the diffraction grating may include a plurality of parallel ridges rising out of the material surface. The diffractive features (whether grooves, ridges, holes, bumps, etc.) may have any of a variety of cross sectional shapes or profiles that provide diffraction including, but not limited to, one or more of a sinusoidal profile, a rectangular profile (e.g., a binary diffraction grating), a triangular profile and a saw tooth profile (e.g., a blazed grating).

According to various examples described herein, a diffraction grating (e.g., a diffraction grating of a diffractive multibeam element, as described below) may be employed to diffractively scatter or couple light out of a light guide (e.g., a plate light guide) as a light beam. In particular, a diffraction angle θₘ of or provided by a locally periodic diffraction grating may be given by equation (1) as:

$${θ}_{m} = {sin}^{- 1} ( n sin {θ}_{i} - \frac{m λ}{d} ) \qquad ( 1 )$$

where λ is a wavelength of the light, m is a diffraction order, n is an index of refraction of a light guide, d is a distance or spacing between features of the diffraction grating, B, is an angle of incidence of light on the diffraction grating. For simplicity, equation (1) assumes that the diffraction grating is adjacent to a surface of the light guide and a refractive index of a material outside of the light guide is equal to one (i.e., nₒᵤₜ=1). In general, the diffraction order m is given by an integer (i.e., m=±1, ±2, . . . ). A diffraction angle θₘ of a light beam produced by the diffraction grating may be given by equation (1). First-order diffraction or more specifically a first-order diffraction angle is provided when the diffraction order m is equal to one (i.e., m=1).

Further, the diffractive features in a diffraction grating may be curved and may also have a predetermined orientation (e.g., a slant or a rotation) relative to a propagation direction of light, according to some embodiments. One or both of the curve of the diffractive features and the orientation of the diffractive features may be configured to control a direction of light coupled-out by the diffraction grating, for example. For example, a principal angular direction of the directional light may be a function of an angle of the diffractive feature at a point at which the light is incident on the diffraction grating relative to a propagation direction of the incident light.

By definition herein, a ‘multibeam element’ is a structure or element of a backlight or a display that produces light that includes a plurality of light beams. A ‘diffractive’ multibeam element is a multibeam element that produces the plurality of light beams by or using diffractive coupling, by definition. In particular, in some embodiments, the diffractive multibeam element may be optically coupled to a light guide of a backlight to provide the plurality of light beams by diffractively coupling out a portion of light guided in the light guide. Further, by definition herein, a diffractive multibeam element comprises a plurality of diffraction gratings within a boundary or extent of the multibeam element. The light beams of the plurality of light beams (or ‘light beam plurality’) produced by a multibeam element have different principal angular directions from one another, by definition herein. In particular, by definition, a light beam of the light beam plurality has a predetermined principal angular direction that is different from another light beam of the light beam plurality. According to various embodiments, the spacing or grating pitch of diffractive features in the diffraction gratings of the diffractive multibeam element may be sub-wavelength (i.e., less than a wavelength of the guided light).

While a multibeam element with a plurality of diffraction gratings may be used as an illustrative example in the discussion that follows, in some embodiments other components may be used in multibeam element, such as at least one of a micro-reflective element and a micro-refractive element. For example, the micro-reflective element may include a triangular-shaped mirror, a trapezoid-shaped mirror, a pyramid-shaped mirror, a rectangular-shaped mirror, a hemispherical-shaped mirror, a concave mirror and/or a convex mirror. In some embodiments, a micro-refractive element may include a triangular-shaped refractive element, a trapezoid-shaped refractive element, a pyramid-shaped refractive element, a rectangular-shaped refractive element, a hemispherical-shaped refractive element, a concave refractive element and/or a convex refractive element.

According to various embodiments, the light beam plurality may represent a light field. For example, the light beam plurality may be confined to a substantially conical region of space or have a predetermined angular spread that includes the different principal angular directions of the light beams in the light beam plurality. As such, the predetermined angular spread of the light beams in combination (i.e., the light beam plurality) may represent the light field.

According to various embodiments, the different principal angular directions of the various light beams in the light beam plurality are determined by a characteristic including, but not limited to, a size (e.g., one or more of length, width, area, and etc.) of the diffractive multibeam element along with a ‘grating pitch’ or a diffractive feature spacing and an orientation of a diffraction grating within diffractive multibeam element. In some embodiments, the diffractive multibeam element may be considered an ‘extended point light source’, i.e., a plurality of point light sources distributed across an extent of the diffractive multibeam element, by definition herein. Further, a light beam produced by the diffractive multibeam element has a principal angular direction given by angular components {θ, ϕ}, by definition herein, and as described above with respect to FIG. 1B.

Herein a ‘collimator’ is defined as substantially any optical device or apparatus that is configured to collimate light. For example, a collimator may include, but is not limited to, a collimating mirror or reflector, a collimating lens, a collimating diffraction grating as well as various combinations thereof.

Herein, a ‘collimation factor,’ denoted a, is defined as a degree to which light is collimated. In particular, a collimation factor defines an angular spread of light rays within a collimated beam of light, by definition herein. For example, a collimation factor σ may specify that a majority of light rays in a beam of collimated light is within a particular angular spread (e.g., +/−σ degrees about a central or principal angular direction of the collimated light beam). The light rays of the collimated light beam may have a Gaussian distribution in terms of angle and the angular spread may be an angle determined at one-half of a peak intensity of the collimated light beam, according to some examples.

Herein, a ‘light source’ is defined as a source of light (e.g., an apparatus or device that emits light). For example, the light source may be a light emitting diode (LED) that emits light when activated. The light source may be substantially any source of light or optical emitter including, but not limited to, one or more of a light emitting diode (LED), a laser, an organic light emitting diode (OLED), a polymer light emitting diode, a plasma-based optical emitter, a fluorescent lamp, an incandescent lamp, and virtually any other source of light. The light produced by a light source may have a color (i.e., may include a particular wavelength of light) or may include a particular wavelength of light (e.g., white light). Moreover, a ‘plurality of light sources of different colors’ is explicitly defined herein as a set or group of light sources in which at least one of the light sources produces light having a color, or equivalently a wavelength, that differs from a color or wavelength of light produced by at least one other light source of the light source plurality. The different colors may include primary colors (e.g., red, green, blue) for example. Further, the ‘plurality of light sources of different colors’ may include more than one light source of the same or substantially similar color as long as at least two light sources of the plurality of light sources are different color light sources (i.e., at least two light sources produce colors of light that are different). Hence, by definition herein, a ‘plurality of light sources of different colors’ may include a first light source that produces a first color of light and a second light source that produces a second color of light, where the second color differs from the first color.

Herein, an ‘arrangement’ or a ‘pattern’ is defined as relationship between elements defined by a relative location of the elements and a number of the elements. More specifically, as used herein, an ‘arrangement’ or a ‘pattern’ does not define a spacing between elements or a size of a side of an array of elements. As defined herein, a ‘square’ arrangement is a rectilinear arrangement of elements that includes an equal number of elements (e.g., cameras, views, etc.) in each of two substantially orthogonal directions (e.g., an x-direction and a y-direction). On the other hand, a ‘rectangular’ arrangement is defined as a rectilinear arrangement that includes a different number of elements in each of two orthogonal directions.

Herein, a spacing or separation between elements of an array is referred to as a ‘baseline’ or equivalently a ‘baseline distance,’ by definition. For example, cameras of an array of cameras may be separated from one another by a baseline distance, which defines a space, or distance between individual cameras of the camera array.

Further by definition herein, the term ‘broad-angle’ as in ‘broad-angle emitted light’ is defined as light having a cone angle that is greater than a cone angle of the view of a multiview image or multiview display. In particular, in some embodiments, the broad-angle emitted light may have a cone angle that is greater than about sixty degrees (60°). In other embodiments, the broad-angle emitted light cone angle may be greater than about fifty degrees (50°), or greater than about forty degrees (40°). For example, the cone angle of the broad-angle emitted light may be about one hundred twenty degrees (120°). Alternatively, the broad-angle emitted light may have an angular range that is greater than plus and minus forty-five degrees (e.g., >±45°) relative to the normal direction of a display. In other embodiments, the broad-angle emitted light angular range may be greater than plus and minus fifty degrees (e.g., >±50°), or greater than plus and minus sixty degrees (e.g., >±60°), or greater than plus and minus sixty-five degrees (e.g., >±65°). For example, the angular range of the broad-angle emitted light may be greater than about seventy degrees on either side of the normal direction of the display (e.g., >±70°). A ‘broad-angle backlight’ is a backlight configured to provide broad-angle emitted light, by definition herein.

In some embodiments, the broad-angle emitted light cone angle may defined to be about the same as a viewing angle of an LCD computer monitor, an LCD tablet, an LCD television, or a similar digital display device meant for broad-angle viewing (e.g., about ±40-65°). In other embodiments, broad-angle emitted light may also be characterized or described as diffuse light, substantially diffuse light, non-directional light (i.e., lacking any specific or defined directionality), or as light having a single or substantially uniform direction.

Embodiments consistent with the principles described herein may be implemented using a variety of devices and circuits including, but not limited to, one or more of integrated circuits (ICs), very large scale integrated (VLSI) circuits, application specific integrated circuits (ASIC), field programmable gate arrays (FPGAs), digital signal processors (DSPs), graphical processor unit (GPU), and the like, firmware, software (such as a program module or a set of instructions), and a combination of two or more of the above. For example, an image processor or other elements described below may all be implemented as circuit elements within an ASIC or a VLSI circuit. Implementations that employ an ASIC or a VLSI circuit are examples of hardware-based circuit implementations.

In another example, an embodiment of the image processor may be implemented as software using a computer programming language (e.g., C/C++) that is executed in an operating environment or a software-based modeling environment (e.g., MATLAB®, MathWorks, Inc., Natick, Mass.) that is executed by a computer (e.g., stored in memory and executed by a processor or a graphics processor of a computer). Note that one or more computer programs or software may constitute a computer-program mechanism, and the programming language may be compiled or interpreted, e.g., configurable or configured (which may be used interchangeably in this discussion), to be executed by a processor or a graphics processor of a computer.

In yet another example, a block, a module or an element of an apparatus, device or system (e.g., image processor, camera, etc.) described herein may be implemented using actual or physical circuitry (e.g., as an IC or an ASIC), while another block, module or element may be implemented in software or firmware. In particular, according to the definitions above, some embodiments described herein may be implemented using a substantially hardware-based circuit approach or device (e.g., ICs, VLSI, ASIC, FPGA, DSP, firmware, etc.), while other embodiments may also be implemented as software or firmware using a computer processor or a graphics processor to execute the software, or as a combination of software or firmware and hardware-based circuitry, for example.

Further, as used herein, the article ‘a’ is intended to have its ordinary meaning in the patent arts, namely ‘one or more’. For example, ‘a camera’ means one or more cameras and as such, ‘the camera’ means ‘the camera(s)’ herein. Also, any reference herein to ‘top’, ‘bottom’, ‘upper’, ‘lower’, ‘up’, ‘down’, ‘front’, back’, ‘first’, ‘second’, ‘left’ or ‘right’ is not intended to be a limitation herein. Herein, the term ‘about’ when applied to a value generally means within the tolerance range of the equipment used to produce the value, or may mean plus or minus 10%, or plus or minus 5%, or plus or minus 1%, unless otherwise expressly specified. Further, the term ‘substantially’ as used herein means a majority, or almost all, or all, or an amount within a range of about 51% to about 100%. Moreover, examples herein are intended to be illustrative only and are presented for discussion purposes and not by way of limitation.

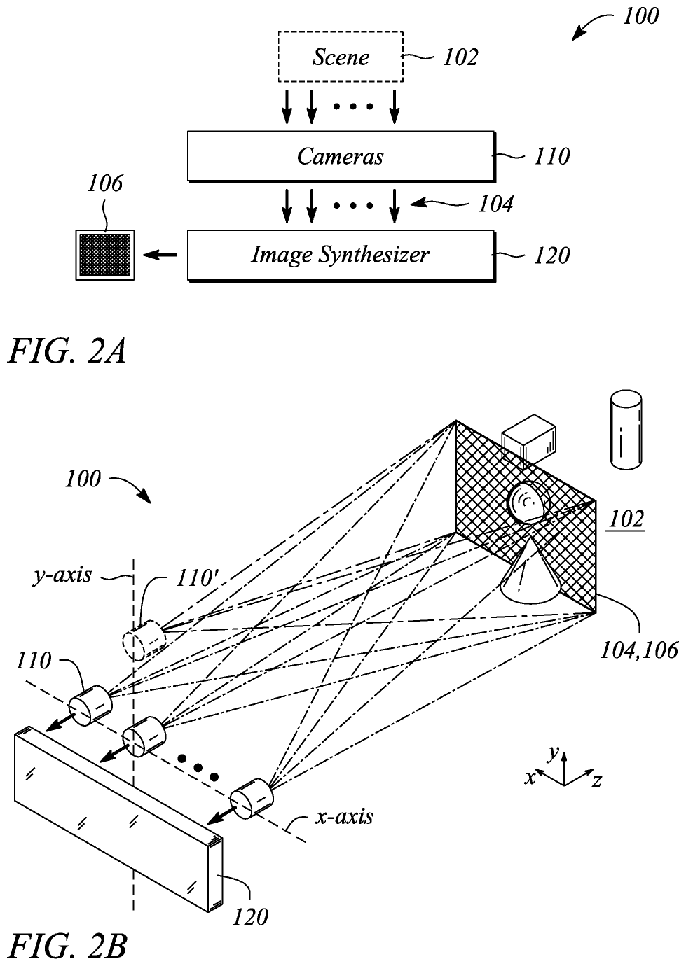

According to some embodiments of the principles described herein, a cross-render multiview camera is provided. FIG. 2A illustrates a diagram of a cross-render multiview camera 100 in an example, according to an embodiment consistent with the principles described herein. FIG. 2B illustrates a perspective view of a cross-render multiview camera 100 in an example, according to an embodiment consistent with the principles described herein. The cross-render multiview camera 100 is configured to capture a plurality of images 104 of a scene 102 and then synthesize or generate a synthesized image of the scene 102. In particular, the cross-render multiview camera 100 may be configured to capture a plurality of images 104 of the scene 102 representing different perspective views of the scene 102 and then generate the synthesized image 106 representing a view of the scene 102 from a perspective that differs from the different perspective views represented by the plurality of images 104. As such, the synthesized image 106 may represent a ‘new’ perspective view of the scene 102, according to various embodiments.

As illustrated, the cross-render multiview camera 100 comprises a plurality of cameras 110 spaced apart from one another along a first axis. For example, the plurality of cameras 110 may be spaced apart from one another as a linear array in an x direction, as illustrated in FIG. 2B. As such, the first axis may comprise the x-axis. Note that while illustrated a being on a common axis (i.e., a linear array), sets of cameras 110 of the camera plurality may be arranges along a several different axes (not illustrated), in some embodiments.

The plurality of cameras 110 is configured to capture the plurality of images 104 of the scene 102. In particular, each camera 110 of the camera plurality may be configured to capture a different one of the images 104 of the image plurality. For example, the camera plurality may comprise two (2) cameras 110, each camera 110 being configured to capture a different one of two images 104 of the image plurality. The two cameras 110 may represent a stereo pair of cameras or simply a ‘stereo camera,’ for example. In other examples, the camera plurality may comprise three (3) cameras 110 configured to capture three (3) images 104, or four (4) cameras 110 configured to capture four (4) images 104, or five (5) cameras 110 configured to capture five (5) images 104 and so on, the captured images 104. Moreover, different images 104 of the image plurality represent different perspective views of the scene 102 by virtue of the cameras 110 being spaced apart from one another along the first axis, e.g., the x-axis as illustrated.

According to various embodiments, the cameras 110 of the camera plurality may comprise substantially any camera or related imaging or image capture device. In particular, the cameras 110 may be digital cameras configured to capture digital images. For example, a digital camera may include digital image sensor such as, but not limited to, a charge-coupled device (CCD) image sensor, a complimentary metal-oxide semiconductor (CMOS) image sensor, or a back-side-illuminated CMOS (BSI-CMOS) sensor. Further, the cameras 110 may be configured to capture one or both of still images (e.g., photographs) and moving images (e.g., video), according to various embodiments. In some embodiments, the cameras 110 capture amplitude or intensity and phase information in the plurality of images.

The cross-render multiview camera 100 illustrated in FIGS. 2A-2B further comprises an image synthesizer 120. The image synthesizer is configured to generate the synthesized image 106 of the scene 102 using a disparity map or a depth map of the scene 102 determined from the image plurality. In particular, the image synthesizer 120 may be configured to determine the disparity map from images 104 of the image plurality (e.g., a pair of images) captured by the camera array. The image synthesizer 120 then may employ the determined disparity map to generate the synthesized image 106 in conjunction with one or more of the images 104 of the image plurality. According to various embodiments, any of a number of different approaches to determining the disparity map (or equivalently the depth map) may be employed. In some embodiments, the image synthesizer 120 is further configured to provide hole-filling one or both in the disparity map and the synthesized image 106. For example, the image synthesizer 120 may employ any of the methods described by Hamzah et al. in, “Literature Survey on Stereo Vision Disparity Map Algorithms,” J. of Sensor, Vol. 2016, Article ID 8742920, or Jain et al., “Efficient Stereo-to-Multiview Synthesis,” ICASSP 2011, pp. 889-892, or by Nguyen et al., “Multiview Synthesis Method and Display Devices with Spatial and Inter-View Consistency, US 2016/0373715 A1, each of which is incorporated herein by reference.

According to various embodiments, the synthesized image 106 generated by the image synthesizer represents a view of the scene 102 from a perspective corresponding to a location of virtual camera 110′ on a second axis displaced from the first axis. For example, cameras 110 of the camera plurality may be arrange and spaced apart from one another in a linear manner along the x-axis and the virtual camera 110′ may be displaced in a y direction from the camera plurality, as illustrated in FIG. 2B.

In some embodiments, the second axis is perpendicular to the first axis. For example, the second axis may be in a y direction (e.g., a y-axis) when the first axis is in the x-direction, as illustrated in FIG. 2B. In other embodiments, the second axis may be parallel to but laterally displaced from the first axis. For example, both the first and second axis may be in the x direction, but the second axis may be laterally displaced in they direction relative to the first axis.

In some embodiments, the image synthesizer 120 is configured to provide a plurality of synthesized images 106 using the disparity map. In particular, each synthesized image 106 of the synthesized image plurality may represent a view of the scene 102 from a different perspective of the scene 102 relative to other synthesized images 106 of the synthesized image plurality. For example, the plurality of synthesized images 106 may include two (2), three (3), four (4), or more synthesized images 106. In turn, the plurality of synthesized images 106 may represent views of the scene 102 corresponding to locations of a similar plurality of virtual cameras 110′, for example. Further, the plurality of virtual cameras 110′ may be located on one or more different axes corresponding to the second axis, in some example. In some embodiments, a number of synthesized images 106 may be equivalent to a number of images 104 captured by the camera plurality.

In some embodiments, the plurality of cameras 110 may comprise a pair of cameras 110a, 110b configured as a stereo camera. Further, the plurality of images 104 of the scene 102 captured by the stereo camera may comprise a stereo pair of images 104 of the scene 102. In these embodiments, the image synthesizer 120 may be configured to provide a plurality of synthesized images 106 representing views of the scene 102 from perspectives corresponding to locations of a plurality of virtual cameras 110′.

In some embodiments, the first axis may be or represent a horizontal axis and the second axis may be or represent a vertical axis orthogonal to the horizontal axis. In these embodiments, the stereo pair of images 104 may be arranged in a horizontal direction corresponding to the horizontal axis and the synthesized image plurality comprising a pair of synthesized images 106 may be arranged in a vertical direction corresponding to the vertical axis.

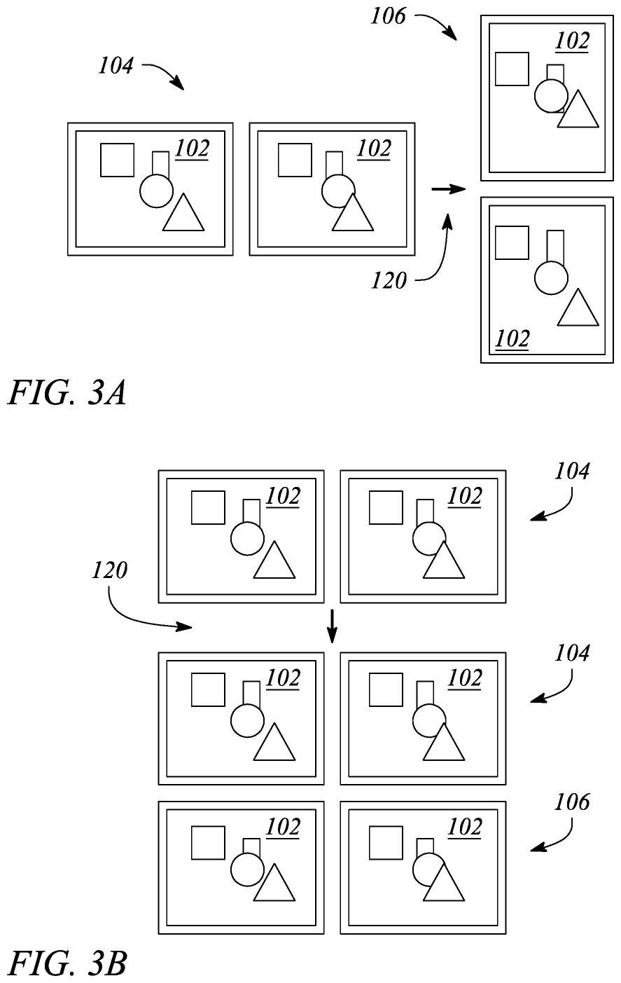

FIG. 3A illustrates a graphic representation of images associated with a cross-render multiview camera 100 in an example, according to an embodiment consistent with the principles described herein. In particular, a left side of FIG. 3A illustrates a stereo pair of images 104 of the scene 102 captured by a pair of cameras 110 acting as a stereo camera. The images 104 in the stereo pair are arranged in the horizontal direction and thus may be referred to being in a landscape orientation, as illustrated. A right side of FIG. 3A illustrates a stereo pair of synthesized images 106 generated by the image synthesizer 120 of the cross-render multiview camera 100. The synthesized images 106 in the stereo pair of synthesized images 106 are arranged in the vertical direction and thus may be referred to as being in a portrait orientation, as illustrated. An arrow between the left and right side stereo images represents the operation of the image synthesizer 120 including determining the disparity map and generating the stereo pair of synthesized images 106. According to various embodiments, FIG. 3A may illustrate conversion of images 104 captured by the camera plurality in the landscape orientation into synthesized images 106 in the portrait orientation. Although not explicitly illustrated, the reverse is also possible where images 104 in the portrait orientation (i.e., captured by vertically arranged cameras 110) are converted by the image synthesizer 120 into or to provide synthesized images 106 in the landscape orientation (i.e., into a horizontal arrangement).

FIG. 3B illustrates a graphic representation of images associated with a cross-render multiview camera 100 in another example, according to an embodiment consistent with the principles described herein. In particular, a top portion of FIG. 3B illustrates a stereo pair of images 104 of the scene 102 captured by a pair of cameras 110 acting as a stereo camera. A bottom portion of FIG. 3B illustrates a stereo pair of synthesized images 106 generated by the image synthesizer 120 of the cross-render multiview camera 100. Moreover, the stereo pair of synthesized images 106 corresponds to a pair of virtual cameras 110′ located on a second axis that is parallel with but displaced from the first axis along which the cameras 110 of the camera plurality are arranged. The stereo pair of images 104 captured by the cameras 110 may be combined with the stereo pair of synthesized images 106 to provide four (4) views of the scene to provide a so-called four-view (4V) multiview image of the scene 102, according to various embodiments.

In some embodiments (not explicitly illustrated in FIGS. 2A-2B), the cross-render multiview camera 100 may further comprise a processing subsystem, a memory subsystem, a power subsystem, and a networking subsystem. The processing subsystem may include one or more devices configured to perform computational operations such as, but not limited to, a microprocessor, a graphics processor unit (GPU) or a digital signal processor (DSP). The memory subsystem may include one or more devices for storing one or both of data and instructions that may be used by the processing subsystem to provide and control operation the cross-render multiview camera 100. For example, stored data and instructions may include, but are not limited to, data and instructions configured to one or more initiate capture of the image plurality using the plurality of cameras 110, implement the image synthesizer 120, and display the multiview content including the images 104 and synthesized image(s) 106 on a display (e.g., a multiview display). For example, memory subsystem may include one or more types of memory including, but not limited to, random access memory (RAM), read-only memory (ROM), and various forms of flash memory.

In some embodiments, instructions stored in the memory subsystem and used by the processing subsystem include, but are not limited to program instructions or sets of instructions and an operating system, for example. The program instructions and operating system may be executed by processing subsystem during operation of the cross-render multiview camera 100, for example. Note that the one or more computer programs may constitute a computer-program mechanism, a computer-readable storage medium or software. Moreover, instructions in the various modules in memory subsystem may be implemented in one or more of a high-level procedural language, an object-oriented programming language, and in an assembly or machine language. Furthermore, the programming language may be compiled or interpreted, e.g., configurable or configured (which may be used interchangeably in this discussion), to be executed by processing subsystem, according to various embodiments.

In various embodiments, the power subsystem may include one or more energy storage components (such as a battery) configured to provide power to other components in the cross-render multiview camera 100. The networking subsystem may include one or more devices and subsystem or modules configured to couple to and communicate on one or both of a wired and a wireless network (i.e., to perform network operations). For example, networking subsystem may include any or all of a Bluetooth™ networking system, a cellular networking system (e.g., a 3G/4G/5G network such as UMTS, LTE, etc.), a universal serial bus (USB) networking system, a networking system based on the standards described in IEEE 802.12 (e.g., a WiFi networking system), an Ethernet networking system.

Note that, while some of the operations in the preceding embodiments may be implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the display technique may be implemented using program instructions, the operating system (such as a driver for display subsystem) or in hardware.

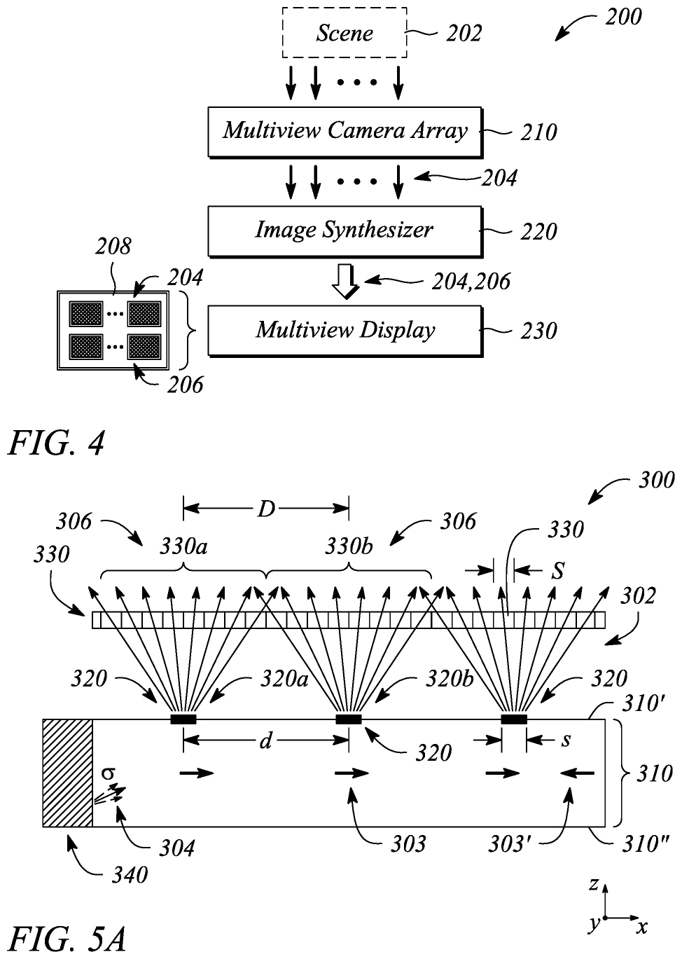

According to other embodiments of the principles described herein, a cross-render multiview system is provided. FIG. 4 illustrates a block diagram of a cross-render multiview system 200 in an example, according to an embodiment consistent with the principles described herein. The cross-render multiview system 200 may be used to capture or image a scene 202. The image may be a multiview image 208, for example. Further, the cross-render multiview system 200 may be configured to display the multiview image 208 of the scene 202, according to various embodiments.

As illustrated in FIG. 4, the cross-render multiview system 200 comprises a multiview camera array 210 having cameras spaced apart from one another along a first axis. According to various embodiments, the multiview camera array 210 is configured to capture a plurality of images 204 of the scene 202. In some embodiments, the multiview camera array 210 may be substantially similar to the plurality of cameras 110, described above with respect to the cross-render multiview camera 100. In particular, the multiview camera array 210 may comprise a plurality of cameras arranged in a linear configuration along the first axis. In some embodiments, the multiview camera array 210 may include cameras that are not on the first axis.

The cross-render multiview system 200 illustrated in FIG. 4 further comprises an image synthesizer 220. The image synthesizer 220 is configured to generate a synthesized image 206 of the scene 202. In particular, the image synthesizer is configured to generate the synthesized image 206 using a disparity map determined from images 204 of the image plurality. In some embodiments, the image synthesizer 220 may be substantially similar to the image synthesizer 120 of the above-described cross-render multiview camera 100. For example, the image synthesizer 220 may be further configured to determine the disparity map from which the synthesized image 206 is generated. Further, the image synthesizer 220 may provide hole-filling in one or both of the disparity map and the synthesized image 206.

As illustrated, the cross-render multiview system 200 further comprises a multiview display 230. The multiview display 230 is configured to display the multiview image 208 of the scene 202 comprising the synthesized image 206. According to various embodiments, the synthesized image 206 represents a view of the scene 202 from a perspective corresponding to a location of virtual camera on a second axis orthogonal to the first axis. Further, the multiview display 230 may include the synthesized image 206 as a view in the multiview image 208 of the scene 202. In some embodiments, multiview image 208 may comprise a plurality of synthesized images 206 corresponding to a plurality of virtual cameras and representing a plurality of different views of the scene 202 from a similar plurality of different perspectives. In other embodiments, the multiview image 208 may comprise the synthesized image 206 along with one or more images 204 of the image plurality. For example, the multiview image 208 may comprise four views (4V), a first two views of the four views being a pair of synthesized images 206 and a second two views of the four views being a pair of images 204 of the image plurality, e.g., as illustrated in FIG. 3B.

In some embodiments, the camera plurality may comprise a pair of cameras of the multiview camera array 210 configured to provide a stereo pair of images 204 of the scene 202. The disparity map may be determined by the image synthesizer 220 using the stereo image pair, in these embodiments. In some embodiments, the image synthesizer 220 is configured to provide a pair of synthesized image 206 of the scene 202. The multiview image 208 may comprise the pair of synthesized images 206 in these embodiments. In some embodiments, the multiview image 208 may further comprise a pair of images 204 of the image plurality.

In some embodiments, the image synthesizer 220 may be implemented in a remote processor. For example, the remote processor may be processor of a cloud computing service or a so-called ‘cloud’ processor. When the image synthesizer 220 is implement as remote processor, the plurality of images 204 may be transmitted to the remote processor by the cross-render multiview system and the synthesized image 206 may then be received from the remote processor by the cross-render multiview system to be displayed using the multiview display 230. Transmission to and from the remote processor may employ the Internet or a similar transmission medium, according to various embodiments. In other embodiments, the image synthesizer 220 may be implemented using another processor such as, but limited to, a processor (e.g., a GPU) of the cross-render multiview system 200, for example. In yet other embodiments, dedicated hardware circuitry (e.g., an ASIC) of the cross-render multiview system 200 may be used to implement the image synthesizer 220.

According to various embodiments, the multiview display 230 of the cross-render multiview system 200 may be substantially any multiview display or display capable of displaying a multiview image. In some embodiments, the multiview display 230 may be a multiview display that employs directional scattering of light and subsequent modulation of the scattered light to provide or display the multiview image.

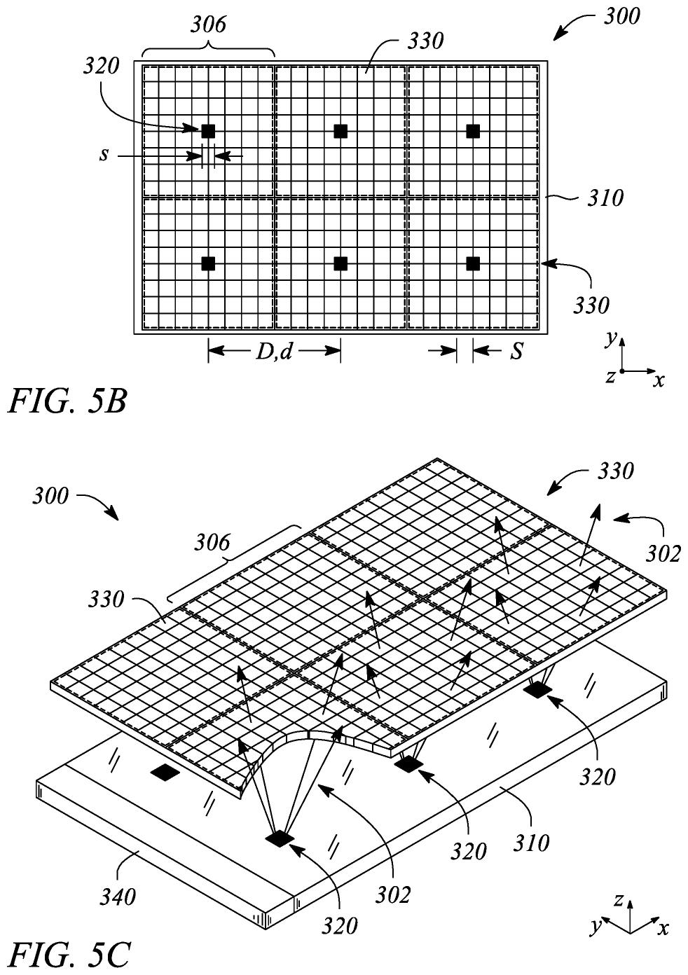

FIG. 5A illustrates a cross-sectional view of a multiview display 300 in an example, according to an embodiment consistent with the principles described herein. FIG. 5B illustrates a plan view of a multiview display 300 in an example, according to an embodiment consistent with the principles described herein. FIG. 5C illustrates a perspective view of a multiview display 300 in an example, according to an embodiment consistent with the principles described herein. The perspective view in FIG. 5C is illustrated with a partial cut-away to facilitate discussion herein only. The multiview display 300 may be employed as the multiview display 230 of the cross-render multiview system 200, according to some embodiments.

The multiview display 300 illustrated in FIGS. 5A-5C is configured to provide a plurality of directional light beams 302 having different principal angular directions from one another (e.g., as a light field). In particular, the provided plurality of directional light beams 302 are configured to be scattered out and directed away from the multiview display 300 in different principal angular directions corresponding to respective view directions of the multiview display 300 or equivalently corresponding to directions of different views of a multiview image (e.g., the multiview image 208 of the cross-render multiview system 200) displayed by the multiview display 300, according to various embodiments. According to various embodiments, the directional light beams 302 may be modulated (e.g., using light valves, as described below) to facilitate the display of information having multiview content, i.e., the multiview image 208. FIGS. 5A-5C also illustrate a multiview pixel 306 comprising sub-pixels and an array of light valves 330, which are described in further detail below.

As illustrated in FIGS. 5A-5C, the multiview display 300 comprises a light guide 310. The light guide 310 is configured to guide light along a length of the light guide 310 as guided light 304 (i.e., a guided light beam). For example, the light guide 310 may include a dielectric material configured as an optical waveguide. The dielectric material may have a first refractive index that is greater than a second refractive index of a medium surrounding the dielectric optical waveguide. The difference in refractive indices is configured to facilitate total internal reflection of the guided light 304 according to one or more guided modes of the light guide 310, for example.

In some embodiments, the light guide 310 may be a slab or plate optical waveguide (i.e., a plate light guide) comprising an extended, substantially planar sheet of optically transparent, dielectric material. The substantially planar sheet of dielectric material is configured to guide the guided light 304 using total internal reflection. According to various examples, the optically transparent material of the light guide 310 may include or be made up of any of a variety of dielectric materials including, but not limited to, one or more of various types of glass (e.g., silica glass, alkali-aluminosilicate glass, borosilicate glass, etc.) and substantially optically transparent plastics or polymers (e.g., poly(methyl methacrylate) or ‘acrylic glass’, polycarbonate, etc.). In some examples, the light guide 310 may further include a cladding layer (not illustrated) on at least a portion of a surface (e.g., one or both of the top surface and the bottom surface) of the light guide 310. The cladding layer may be used to further facilitate total internal reflection, according to some examples.

Further, according to some embodiments, the light guide 310 is configured to guide the guided light 304 according to total internal reflection at a non-zero propagation angle between a first surface 310′ (e.g., ‘front’ surface or side) and a second surface 310″ (e.g., ‘back’ surface or side) of the light guide 310. In particular, the guided light 304 is guided and thus propagates by reflecting or ‘bouncing’ between the first surface 310′ and the second surface 310″ of the light guide 310 at the non-zero propagation angle. In some embodiments, a plurality of guided light beams of the guided light 304 comprising different colors of light may be guided by the light guide 310 at respective ones of different color-specific, non-zero propagation angles. Note that the non-zero propagation angle is not illustrated in FIGS. 5A-5C for simplicity of illustration. However, a bold arrow depicting a propagation direction 303 illustrates a general propagation direction of the guided light 304 along the light guide length in FIG. 5A.

As defined herein, a ‘non-zero propagation angle’ is an angle relative to a surface (e.g., the first surface 310′ or the second surface 310″) of the light guide 310. Further, the non-zero propagation angle is both greater than zero and less than a critical angle of total internal reflection within the light guide 310, according to various embodiments. For example, the non-zero propagation angle of the guided light 304 may be between about ten degrees (10°) and about fifty degrees (50°) or, in some examples, between about twenty degrees (20°) and about forty degrees (40°), or between about twenty-five degrees (25°) and about thirty-five degrees (35°). For example, the non-zero propagation angle may be about thirty degrees (30°). In other examples, the non-zero propagation angle may be about 20°, or about 25°, or about 35°. Moreover, a specific non-zero propagation angle may be chosen (e.g., arbitrarily) for a particular implementation as long as the specific non-zero propagation angle is chosen to be less than the critical angle of total internal reflection within the light guide 310.

The guided light 304 in the light guide 310 may be introduced or coupled into the light guide 310 at the non-zero propagation angle (e.g., about 30°-35°). In some examples, a coupling structure such as, but not limited to, a grating, a lens, a mirror or similar reflector (e.g., a tilted collimating reflector), a diffraction grating and a prism (not illustrated) as well as various combinations thereof may facilitate coupling light into an input end of the light guide 310 as the guided light 304 at the non-zero propagation angle. In other examples, light may be introduced directly into the input end of the light guide 310 either without or substantially without the use of a coupling structure (i.e., direct or ‘butt’ coupling may be employed). Once coupled into the light guide 310, the guided light 304 (e.g., as a guided light beam) is configured to propagate along the light guide 310 in the propagation direction 303 that may be generally away from the input end (e.g., illustrated by bold arrows pointing along an x-axis in FIG. 5A).

Further, the guided light 304, or equivalently the guided light beam, produced by coupling light into the light guide 310 may be a collimated light beam, according to various embodiments. Herein, a ‘collimated light’ or a ‘collimated light beam’ is generally defined as a beam of light in which rays of the light beam are substantially parallel to one another within the light beam (e.g., the guided light beam). Also by definition herein, rays of light that diverge or are scattered from the collimated light beam are not considered to be part of the collimated light beam. In some embodiments (not illustrated), the multiview display 300 may include a collimator, such as a grating, a lens, reflector or mirror, as described above, (e.g., tilted collimating reflector) to collimate the light, e.g., from a light source. In some embodiments, the light source itself comprises a collimator. In either case, the collimated light provided to the light guide 310 is a collimated guided light beam. The guided light 304 may be collimated according to or having a collimation factor σ, in various embodiments. Alternatively, the guided light 304 may be uncollimated, in other embodiments.

In some embodiments, the light guide 310 may be configured to ‘recycle’ the guided light 304. In particular, the guided light 304 that has been guided along the light guide length may be redirected back along that length in another propagation direction 303′ that differs from the propagation direction 303. For example, the light guide 310 may include a reflector (not illustrated) at an end of the light guide 310 opposite to an input end adjacent to the light source. The reflector may be configured to reflect the guided light 304 back toward the input end as recycled guided light. In some embodiments, another light source may provide guided light 304 in the other propagation direction 303′ instead of or in addition to light recycling (e.g., using a reflector). One or both of recycling the guided light 304 and using another light source to provide guided light 304 having the other propagation direction 303′ may increase a brightness of the multiview display 300 (e.g., increase an intensity of the directional light beams 302) by making guided light available more than once, for example, to multibeam elements, described below.

In FIG. 5A, a bold arrow indicating a propagation direction 303′ of recycled guided light (e.g., directed in a negative x-direction) illustrates a general propagation direction of the recycled guided light within the light guide 310. Alternatively (e.g., as opposed to recycling guided light), guided light 304 propagating in the other propagation direction 303′ may be provided by introducing light into the light guide 310 with the other propagation direction 303′ (e.g., in addition to guided light 304 having the propagation direction 303).

As illustrated in FIGS. 5A-5C, the multiview display 300 further comprises an array of multibeam elements 320 spaced apart from one another along the light guide length. In particular, the multibeam elements 320 of the multibeam element array are separated from one another by a finite space and represent individual, distinct elements along the light guide length. That is, by definition herein, the multibeam elements 320 of the multibeam element array are spaced apart from one another according to a finite (i.e., non-zero) inter-element distance (e.g., a finite center-to-center distance). Further, the multibeam elements 320 of the plurality generally do not intersect, overlap or otherwise touch one another, according to some embodiments. That is, each multibeam element 320 of the plurality is generally distinct and separated from other ones of the multibeam elements 320.

According to some embodiments, the multibeam elements 320 of the multibeam element array may be arranged in either a 1D array or a 2D array. For example, the multibeam elements 320 may be arranged as a linear 1D array. In another example, the multibeam elements 320 may be arranged as a rectangular 2D array or as a circular 2D array. Further, the array (i.e., 1D or 2D array) may be a regular or uniform array, in some examples. In particular, an inter-element distance (e.g., center-to-center distance or spacing) between the multibeam elements 320 may be substantially uniform or constant across the array. In other examples, the inter-element distance between the multibeam elements 320 may be varied one or both of across the array and along the length of the light guide 310.

According to various embodiments, a multibeam element 320 of the multibeam element array is configured to provide, couple out or scatter out a portion of the guided light 304 as the plurality of directional light beams 302. For example, the guided light portion may be coupled out or scattered out using one or more of diffractive scattering, reflective scattering, and refractive scattering or coupling, according to various embodiments. FIGS. 5A and 5C illustrate the directional light beams 302 as a plurality of diverging arrows depicted as being directed way from the first (or front) surface 310′ of the light guide 310. Further, according to various embodiments, a size of the multibeam element 320 is comparable to a size of a sub-pixel (or equivalently a light valve 330) of a multiview pixel 306, as defined above and further described below and illustrated in FIGS. 5A-5C. Herein, the ‘size’ may be defined in any of a variety of manners to include, but not be limited to, a length, a width or an area. For example, the size of a sub-pixel or a light valve 330 may be a length thereof and the comparable size of the multibeam element 320 may also be a length of the multibeam element 320. In another example, the size may refer to an area such that an area of the multibeam element 320 may be comparable to an area of the sub-pixel (or equivalently the light value 330).

In some embodiments, the size of the multibeam element 320 is comparable to the sub-pixel size such that the multibeam element size is between about fifty percent (50%) and about two hundred percent (200%) of the sub-pixel size. For example, if the multibeam element size is denoted ‘s’ and the sub-pixel size is denoted ‘S’ (e.g., as illustrated in FIG. 5A), then the multibeam element size s may be given by

½S≤s≤2S

In other examples, the multibeam element size is in a range that is greater than about sixty percent (60%) of the sub-pixel size, or greater than about seventy percent (70%) of the sub-pixel size, or greater than about eighty percent (80%) of the sub-pixel size, or greater than about ninety percent (90%) of the sub-pixel size, and that is less than about one hundred eighty percent (180%) of the sub-pixel size, or less than about one hundred sixty percent (160%) of the sub-pixel size, or less than about one hundred forty (140%) of the sub-pixel size, or less than about one hundred twenty percent (120%) of the sub-pixel size. For example, by ‘comparable size’, the multibeam element size may be between about seventy-five percent (75%) and about one hundred fifty (150%) of the sub-pixel size. In another example, the multibeam element 320 may be comparable in size to the sub-pixel where the multibeam element size is between about one hundred twenty-five percent (125%) and about eighty-five percent (85%) of the sub-pixel size. According to some embodiments, the comparable sizes of the multibeam element 320 and the sub-pixel may be chosen to reduce, or in some examples to minimize, dark zones between views of the multiview display. Moreover, the comparable sizes of the multibeam element 320 and the sub-pixel may be chosen to reduce, and in some examples to minimize, an overlap between views (or view pixels) of the multiview display.

The multiview display 300 illustrated in FIGS. 5A-5C further comprises the array of light valves 330 configured to modulate the directional light beams 302 of the directional light beam plurality. In various embodiments, different types of light valves may be employed as the light valves 330 of the light valve array including, but not limited to, one or more of liquid crystal light valves, electrophoretic light valves, and light valves based on electrowetting.

As illustrated in FIGS. 5A-5C, different ones of the directional light beams 302 having different principal angular directions pass through and may be modulated by different ones of the light valves 330 in the light valve array. Further, as illustrated, a light valve 330 of the array corresponds to a sub-pixel of the multiview pixel 306, and a set of the light valves 330 corresponds to a multiview pixel 306 of the multiview display. In particular, a different set of light valves 330 of the light valve array is configured to receive and modulate the directional light beams 302 from a corresponding one of the multibeam elements 320, i.e., there is one unique set of light valves 330 for each multibeam element 320, as illustrated.

As illustrated in FIG. 5A, a first light valve set 330a is configured to receive and modulate the directional light beams 302 from a first multibeam element 320a. Further, a second light valve set 330b is configured to receive and modulate the directional light beams 302 from a second multibeam element 320b. Thus, each of the light valve sets (e.g., the first and second light valve sets 330a, 330b) in the light valve array corresponds, respectively, both to a different multibeam element 320 (e.g., elements 320a, 320b) and to a different multiview pixel 306, with individual light valves 330 of the light valve sets corresponding to the sub-pixels of the respective multiview pixels 306, as illustrated in FIG. 5A.

Note that, as illustrated in FIG. 5A, the size of a sub-pixel of a multiview pixel 306 may correspond to a size of a light valve 330 in the light valve array. In other examples, the sub-pixel size may be defined as a distance (e.g., a center-to-center distance) between adjacent light valves 330 of the light valve array. For example, the light valves 330 may be smaller than the center-to-center distance between the light valves 330 in the light valve array. The sub-pixel size may be defined as either the size of the light valve 330 or a size corresponding to the center-to-center distance between the light valves 330, for example.

In some embodiments, a relationship between the multibeam elements 320 and corresponding multiview pixels 306 (i.e., sets of sub-pixels and corresponding sets of light valves 330) may be a one-to-one relationship. That is, there may be an equal number of multiview pixels 306 and multibeam elements 320. FIG. 5B explicitly illustrates by way of example the one-to-one relationship where each multiview pixel 306 comprising a different set of light valves 330 (and corresponding sub-pixels) is illustrated as surrounded by a dashed line. In other embodiments (not illustrated), the number of multiview pixels 306 and the number of multibeam elements 320 may differ from one another.

In some embodiments, an inter-element distance (e.g., center-to-center distance) between a pair of multibeam elements 320 of the plurality may be equal to an inter-pixel distance (e.g., a center-to-center distance) between a corresponding pair of multiview pixels 306, e.g., represented by light valve sets. For example, as illustrated in FIG. 5A, a center-to-center distance d between the first multibeam element 320a and the second multibeam element 320b is substantially equal to a center-to-center distance D between the first light valve set 330a and the second light valve set 330b. In other embodiments (not illustrated), the relative center-to-center distances of pairs of multibeam elements 320 and corresponding light valve sets may differ, e.g., the multibeam elements 320 may have an inter-element spacing (i.e., center-to-center distance d) that is one of greater than or less than a spacing (i.e., center-to-center distance D) between light valve sets representing multiview pixels 306.

In some embodiments, a shape of the multibeam element 320 is analogous to a shape of the multiview pixel 306 or equivalently, to a shape of a set (or ‘sub-array’) of the light valves 330 corresponding to the multiview pixel 306. For example, the multibeam element 320 may have a square shape and the multiview pixel 306 (or an arrangement of a corresponding set of light valves 330) may be substantially square. In another example, the multibeam element 320 may have a rectangular shape, i.e., may have a length or longitudinal dimension that is greater than a width or transverse dimension. In this example, the multiview pixel 306 (or equivalently the arrangement of the set of light valves 330) corresponding to the multibeam element 320 may have an analogous rectangular shape. FIG. 5B illustrates a top or plan view of square-shaped multibeam elements 320 and corresponding square-shaped multiview pixels 306 comprising square sets of light valves 330. In yet other examples (not illustrated), the multibeam elements 320 and the corresponding multiview pixels 306 have various shapes including or at least approximated by, but not limited to, a triangular shape, a hexagonal shape, and a circular shape.

Further (e.g., as illustrated in FIG. 5A), each multibeam element 320 is configured to provide directional light beams 302 to one and only one multiview pixel 306 at a given time based on the set of sub-pixels that are assigned to a particular multiview pixel 306, according to some embodiments. In particular, for a given one of the multibeam elements 320 and an assignment of the set of sub-pixels to a particular multiview pixel 306, the directional light beams 302 having different principal angular directions corresponding to the different views of the multiview display are substantially confined to the single corresponding multiview pixel 306 and the sub-pixels thereof, i.e., a single set of light valves 330 corresponding to the multibeam element 320, as illustrated in FIG. 5A. As such, each multibeam element 320 of the multiview display 300 provides a corresponding set of directional light beams 302 that has a set of the different principal angular directions corresponding to the different views of the multiview display 300 (i.e., the set of directional light beams 302 contains a light beam having a direction corresponding to each of the different view directions).

As illustrated, the multiview display 300 may further comprise a light source 340. According to various embodiments, the light source 340 is configured to provide the light to be guided within light guide 310. In particular, the light source 340 may be located adjacent to an entrance surface or end (input end) of the light guide 310. In various embodiments, the light source 340 may comprise substantially any source of light (e.g., optical emitter) including, but not limited to, an LED, a laser (e.g., laser diode) or a combination thereof. In some embodiments, the light source 340 may comprise an optical emitter configured produce a substantially monochromatic light having a narrowband spectrum denoted by a particular color. In particular, the color of the monochromatic light may be a primary color of a particular color space or color model (e.g., a red-green-blue (RGB) color model). In other examples, the light source 340 may be a substantially broadband light source configured to provide substantially broadband or polychromatic light. For example, the light source 340 may provide white light. In some embodiments, the light source 340 may comprise a plurality of different optical emitters configured to provide different colors of light. The different optical emitters may be configured to provide light having different, color-specific, non-zero propagation angles of the guided light corresponding to each of the different colors of light.

In some embodiments, the light source 340 may further comprise a collimator. The collimator may be configured to receive substantially uncollimated light from one or more of the optical emitters of the light source 340. The collimator is further configured to convert the substantially uncollimated light into collimated light. In particular, the collimator may provide collimated light having the non-zero propagation angle and being collimated according to a predetermined collimation factor σ, according to some embodiments. Moreover, when optical emitters of different colors are employed, the collimator may be configured to provide the collimated light having one or both of different, color-specific, non-zero propagation angles and having different color-specific collimation factors. The collimator is further configured to communicate the collimated light beam to the light guide 310 to propagate as the guided light 304, described above.

In some embodiments, the multiview display 300 is configured to be substantially transparent to light in a direction through the light guide 310 orthogonal to (or substantially orthogonal) to a propagation direction 303, 303′ of the guided light 304. In particular, the light guide 310 and the spaced apart multibeam elements 320 allow light to pass through the light guide 310 through both the first surface 310′ and the second surface 310″, in some embodiments. Transparency may be facilitated, at least in part, due to both the relatively small size of the multibeam elements 320 and the relative large inter-element spacing (e.g., one-to-one correspondence with the multiview pixels 306) of the multibeam element 320. Further, the multibeam elements 320 may also be substantially transparent to light propagating orthogonal to the light guide surfaces 310′, 310″, according to some embodiments.

According to various embodiments, a wide variety of optical components may be used to generate the directional light beams 302, including, diffraction gratings, micro-reflective elements and/or micro-refractive elements optically connected to the light guide 310 to scatter out the guided light 304 as the directional light beams 302. Note that these optical components may be located at the first surface 310′, the second surface 310″, or even between the first and second surfaces 310′, 310″ of the light guide 310. Furthermore, an optical component may be a ‘positive feature’ that protrudes out from either the first surface 310′ or the second surface 310″, or it may be a ‘negative feature’ that is recessed into either the first surface 310′ or the second surface 310″, according to some embodiments.

In some embodiments, light guide 310, the multibeam elements 320, the light source 340 and/or an optional collimator serve as a multiview backlight. This multiview backlight may be used in conjunction with the light valve array in the multiview display 300, e.g., as the multiview display 230. For example, the multiview backlight may serve as a source of light (often as a panel backlight) for the array of light valves 330, which modulate the directional light beams 302 provided by the multiview backlight to provide the directional views of the multiview image 208, as described above.

In some embodiments, the multiview display 300 may further comprise a broad-angle backlight. In particular, the multiview display 300 (or multiview display 230 of the cross-render multiview system 200) may include a broad-angle backlight in addition to the multiview backlight, described above. The broad-angle backlight may be adjacent to the multiview backlight, for example.

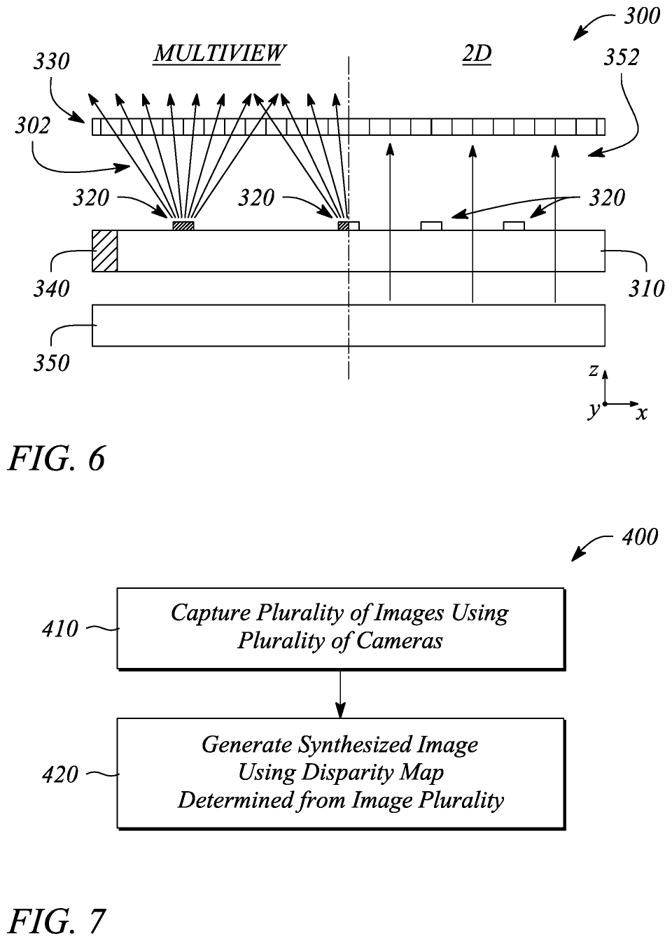

FIG. 6 illustrates a cross-sectional view of a multiview display 300 including a broad-angle backlight 350 in an example, according to an embodiment consistent with the principles described herein. As illustrated, the broad-angle backlight 350 is configured to provide broad-angle emitted light 352 during a first mode. The multiview backlight (e.g., the light guide 310, multibeam elements 320, and light source 340) may be configured to provide the directional emitted light as the directional light beams 302 during a second mode, according to various embodiments. Further, the array of light valves is configured to modulate the broad-angle emitted light 352 to provide a two-dimensional (2D) image during the first mode and to modulate the directional emitted light (or directional light beams 302) to provide the multiview image during the second mode. For example, when the multiview display 300 illustrated in FIG. 6 is employed as the multiview display 230 of the cross-render multiview system 200, the 2D image may be captured by a camera or cameras of the multiview camera array 210. As such, the 2D image may simply represent one of the directional views of the scene 202 during the second mode, according to some embodiments.

As illustrated on a left side of FIG. 6, the multiview image (MULTIVIEW) may be provided using the multiview backlight by activating the light source 340 to provide directional light beams 302 scattered from the light guide 310 using the multibeam elements 320. Alternatively, as illustrated on a right side of FIG. 6, the 2D image may be provided by inactivating the light source 340 and activating the broad-angle backlight 350 to provide broad-angle emitted light 352 to the array of light valves 330. As such, the multiview display 300 including the broad-angle backlight 350 may be switched between displaying the multiview image and displaying the 2D image, according to various embodiments.

In accordance with other embodiments of the principles described herein, a method of cross-render multiview imaging is provided. FIG. 7 illustrates a flow chart of a method 400 of cross-render multiview imaging in an example, according to an embodiment consistent with the principles described herein. As illustrated in FIG. 7, the method 400 of cross-render multiview imaging comprises capturing 410 a plurality of images of a scene using a plurality of cameras spaced apart from one another along a first axis. In some embodiments, the plurality of images and the plurality of cameras may be substantially similar to the plurality of images 104 and plurality of cameras 110, respectively, of the the cross-render multiview camera 100. Likewise, the scene may be substantially similar to the scene 102, according to some embodiments.

The method 400 of cross-render multiview imaging illustrated in FIG. 7 further comprises generating 420 a synthesized image of the scene using a disparity map of the scene determined from the image plurality. According to various embodiments, the synthesized image represents a view of the scene from a perspective corresponding to a location of virtual camera on a second axis displaced from the first axis. In some embodiments, the image synthesizer may be substantially similar to the image synthesizer 120 in the cross-render multiview camera 100, described above. In particular, the image synthesizer may determine the disparity map from images of the image plurality, according to various embodiments.

In some embodiments (not illustrated), the method 400 of cross-render multiview imaging may further comprise hole-filling one or both of in the disparity map and the synthesized image. Hole-filling may be implemented by the image synthesizer, for example.

In some embodiments, the camera plurality may comprise a pair of cameras configured to capture a stereo pair of images of the scene. The disparity map may be determined using the stereo image pair, in these embodiments. Further, generating 420 a synthesized image may produce a plurality of synthesized images representing views of the scene from perspectives corresponding to locations of a similar plurality of virtual cameras.

In some embodiments (not illustrated), the method 400 of cross-render multiview imaging further comprises displaying the synthesized image as a view of a multiview image using a multiview display. In particular, the multiview image may comprise one or more synthesized image representing different views of the multiview image displayed by the multiview display. Further, the multiview image may comprise views representing one or more images of the image plurality. For example, the multiview image may comprise either a stereo pair of synthesized images as illustrated in FIG. 3A or a stereo pair of synthesized images and a pair of images of the image plurality as illustrated in FIG. 3B. In some embodiments, the multiview display may be substantially similar to the multiview display 230 of the cross-render multiview system 200 or substantially similar to the multiview display 300, described above.

Thus, there have been described examples and embodiments of a cross-render multiview camera, cross-render multiview system, and a method of cross-render multiview imaging that provide a synthesized image from a disparity/depth map of images captured by a plurality of cameras. It should be understood that the above-described examples are merely illustrative of some of the many specific examples that represent the principles described herein. Clearly, those skilled in the art can readily devise numerous other arrangements without departing from the scope as defined by the following claims.

What is claimed is:

1. A cross-render multiview camera comprising:
a plurality of cameras spaced apart from one another along a first axis, the plurality of cameras being configured to capture a plurality of images of a scene; and
an image synthesizer configured to generate a synthesized image of the scene using a disparity map of the scene determined from the image plurality,
wherein the synthesized image represents a view of the scene from a perspective corresponding to a location of a virtual camera on a second axis displaced from the first axis.

2. The cross-render multiview camera of claim 1, wherein the second axis is perpendicular to the first axis.

3. The cross-render multiview camera of claim 1, wherein the image synthesizer is configured to provide a plurality of synthesized images using the disparity map, each synthesized image of the synthesized image plurality representing a view of the scene from a different perspective of the scene relative to other synthesized images of the synthesized image plurality.

4. The cross-render multiview camera of claim 1, wherein the plurality of cameras comprises a pair of cameras configured as a stereo camera and the plurality of images of the scene captured by the stereo camera comprising a stereo pair of images of the scene, the image synthesizer being configured to provide a plurality of synthesized images representing views of the scene from perspectives corresponding to locations of a plurality of virtual cameras.

5. The cross-render multiview camera of claim 4, wherein the first axis is a horizontal axis and the second axis is a vertical axis orthogonal to the horizontal axis, the stereo pair of images being arranged in a horizontal direction corresponding to the horizontal axis and the synthesized image plurality comprising a pair of synthesized images arranged in a vertical direction corresponding to the vertical axis.

6. The cross-render multiview camera of claim 1, wherein the image synthesizer is further configured to provide hole-filling one or both in the disparity map and the synthesized image.

7. A cross-render multiview system comprising the cross-render multiview camera of claim 1, the multiview system further comprising a multiview display configured to display the synthesized image as a view of a multiview image representing the scene.

8. The cross-render multiview system of claim 7, wherein the multiview display is further configured to display the plurality of images from cameras of the camera plurality as other views of the multiview image.

9. A cross-render multiview system comprising:
a multiview camera array having cameras spaced apart from one another along a first axis, the multiview camera array being configured to capture a plurality of images of a scene;
an image synthesizer configured to generate a synthesized image of the scene using a disparity map determined from the image plurality; and
a multiview display configured to display a multiview image of the scene comprising the synthesized image,
wherein the synthesized image represents a view of the scene from a perspective corresponding to a virtual camera located on a second axis orthogonal to the first axis.

10. The cross-render multiview system of claim 9, wherein the multiview camera array comprises a pair of cameras configured to provide a stereo pair of images of the scene, the disparity map being determined by the image synthesizer using the stereo image pair.

11. The cross-render multiview system of claim 9, wherein the image synthesizer is configured to provide a pair of synthesized image of the scene, the multiview image comprising the pair of synthesized images and a pair of images of the image plurality.

12. The cross-render multiview system of claim 9, wherein the image synthesizer is implemented in a remote processor, the plurality of images being transmitted to the remote processor by the cross-render multiview system and the synthesized image being received from the remote processor by the cross-render multiview system to be displayed using the multiview display.

13. The cross-render multiview system of claim 9, wherein the multiview display comprises:
a light guide configured to guide light;
an array of multibeam elements spaced apart from one another and configured to scatter out guided light from the light guide as directional light beams having directions corresponding to view directions of the multiview image; and
a light valve array configured to modulate the directional light beams to provide the multiview image,
wherein a multibeam element of the array of multibeam elements has a size comparable to a size of a light valve of the light valve array and a shape analogous to a shape of a multiview pixel associated with the multibeam element.

14. The cross-render multiview system of claim 13, wherein the multibeam element of the array of multibeam elements comprises one or more of a diffraction grating, a micro-reflective element and a micro-refractive element optically connected to the light guide to scatter out the guided light as the directional light beams.

15. The cross-render multiview system of claim 13, wherein the multiview display further comprises a light source optically coupled to an input of the light guide, the light source being configured to provide the guided light one or both of having a non-zero propagation angle and being collimated according to a predetermined collimation factor.

16. The cross-render multiview system of claim 13, wherein the multiview display further comprises a broad-angle backlight configured to provide broad-angle emitted light during a first mode, the light guide and multibeam element array being configured to provide the directional light beams during a second mode,
wherein the light valve array is configured to modulate the broad-angle emitted light to provide a two-dimensional image during the first mode and to modulate the directional light beams to provide the multiview image during the second mode.

17. A method of cross-render multiview imaging, the method comprising:
capturing a plurality of images of a scene using a plurality of cameras spaced apart from one another along a first axis; and
generating a synthesized image of the scene using a disparity map of the scene determined from the image plurality,
wherein the synthesized image represents a view of the scene from a perspective corresponding to a location of a virtual camera on a second axis displaced from the first axis.

18. The method of cross-render multiview imaging of claim 17, further comprising providing hole-filling one or both of in the disparity map and the synthesized image.

19. The method of cross-render multiview imaging of claim 17, wherein the camera plurality comprises a pair of cameras configured to capture a stereo pair of images of the scene, the disparity map being determined using the stereo image pair, and wherein generating a synthesized image produces a plurality of synthesized images representing views of the scene from perspectives corresponding to locations of a similar plurality of virtual cameras.

20. The method of cross-render multiview imaging of claim 17, further comprising displaying the synthesized image as a view of a multiview image using a multiview display.
